(19) United States
(12) Patent Application Publication
(10) Pub. No.: US 2007/0289870 A1
(43) Pub. Date: Dec. 20, 2007

(54) Ammonia Gas Sensor With Dissimilar Electrodes

(76) Inventors: Balakrishnan G. Nair, Sandy, UT (US); Jesse Nachias, Prescott, AZ (US); Troy Small, Midvale, UT (US)

Correspondence Address: CERAMATEC, INC., 2425 SOUTH 900 WEST, SALT LAKE CITY, UT, 84119, US

(21) Appl. No.: 11/763,310

(22) Filed: Jun. 14, 2007

Related U.S. Application Data
(60) Provisional application No. 60/813,502, filed on Jun. 14, 2006.

(51) Int. Cl. G01N 27/26

(52) U.S. Cl. 204/424

(57) ABSTRACT

A sensing apparatus to measure ammonia in a gas mixture. The sensing apparatus includes a sensing element, which includes substrate, a first electrode assembly, and a second electrode assembly. The first electrode assembly includes a first sensor electrode coupled to the substrate. The first electrode assembly is configured to react to the ammonia in the gas mixture. The second electrode assembly includes a second sensor electrode coupled to the substrate. The second electrode assembly is configured to react to the ammonia in the gas mixture. The first and second electrode assemblies are configured to generate a differential electrical signal in response to the ammonia detected by the second electrode assembly.

### CROSS-REFERENCE TO RELATED APPLICATIONS

This application claims the benefit of U.S. Provisional Application No. 60/813,502, filed on Jun. 14, 2006, which is incorporated by reference herein in its entirety.

### BACKGROUND

Ammonia (NH₃) is used in emissions control systems to mitigate nitrogen oxide (NO_{X}) emissions. In order to determine if the proper amount of ammonia or urea is used in an exhaust stream, the residual gaseous ammonia in the exhaust stream may be measured using an ammonia sensor. For control applications such as emissions control systems, it is useful if the accuracy of the ammonia measurement is ±1 part per million (ppm) and the detection limit is as low as 1 ppm. However, conventional ammonia sensors are not suitable for measuring ammonia in combustion applications because of the high temperatures of the exhaust stream.

One conventional ammonia sensor uses a polymer molecular sieve. The conventional measurement techniques using a polymer molecular sieve preclude use at high temperatures because polymers are not chemically stable at such temperatures.

Another conventional ammonia sensor is implemented using optical sensors such as infrared (IR) detectors and optic-fiber-based sensors. Although optical sensors generally provide accurate gas measurement with little cross-sensitivity to other gas constituents, optical sensors are not suitable for mobile applications because the gas inputs are transferred to an analysis chamber, resulting in long lag times. Further, the associated equipment for such optical sensors is generally bulky and expensive. In addition, the use of polymer or other volatile sensing materials necessitates relatively cool gas temperatures (i.e., generally less than 100° C.).

Another conventional ammonia sensor is based on semiconductors such as metal oxides or polymers. These conventional ammonia sensors measure a change in resistance or capacitance of the semiconductor material as a function of adsorbed gas species. However, semiconductor based sensors measure bulk properties based on adsorption of gases, and there is a significant issue of cross-sensitivity as all gases tend to adsorb on high-surface area ceramic materials, resulting in significant errors in measurement. In order to mitigate the cross-sensitivity of semiconductor based ammonia sensors with carbon monoxide (CO) and nitrogen oxides (NO_{X}), some semiconductor sensors use an “electronic nose” based on a number of semiconductor sensors operating in parallel to generate a series of responses in the presence of a mixture of gases. This combination of sensors results in a need for very complex electronics to calculate the ammonia concentration, which is undesirable and expensive. Another problem with conventional semiconductor sensors and electronic noses is that they have a low maximum temperature for use. Polymer-based sensors are useful at temperatures below 150° C. due to the limitations of the thermal stability of polymers above that temperature. Metal oxide semiconductor sensors are typically more sensitive around 300° C., and they generally lose their sensitivity above 450° C., since the adsorption of most gases decreases above that temperature. Additionally, semiconductor sensors typically have a long response time due to fluctuations in ammonia concentration since they are kinetically limited by gas adsorption. For these reasons, electronic nose sensors are generally more suitable for air quality monitoring rather than for emissions control systems.

Other conventional ammonia sensors are implemented using solid-state electrochemical ceramic sensors. These devices can be broadly categorized into potentiometric and amperometric sensors, based on whether the monitored parameter is the electrochemical potential or the current through the device at a fixed applied potential. Potentiometric sensors can be further categorized into equilibrium-potential-based devices and mixed-potential-based devices. There are three main categories of equilibrium-potential-based sensors, originally categorized as Type I, Type II, and Type III sensors. The classification is relative to the nature of the electrochemical potential, based on the interaction of the target gas with the device. Type I sensors generate a potential due to the interaction of the target gas with mobile ions in a solid electrolyte (e.g. O₂ sensors with yttria-stabilized zirconia (YSZ), an O²⁻ ion conductor), whereas Type II sensors generate a potential due to the interaction of a target gas with immobile ions in a solid electrolyte (e.g., sensors based on CO₂₋K⁺ ion interaction). Type III sensors show no such direct relationship without the assistance of an auxiliary phase. Type II and Type III sensors are unsuitable for high-temperature applications due to the nature of the materials (e.g., generally nitrates) used, which are unstable and sometimes explosive at high temperatures.

In contrast, mixed-potential sensors are implemented with metal, metal oxide, or perovskite sensing electrodes on an oxygen ion conducting membrane. Also, mixed-potential sensors can operate effectively at temperatures as high as 650° C., and they do not require elaborate pumping cells for removal of oxygen. Additionally, mixed-potential sensors can be fabricated in very compact shapes using relatively easy and cost-effective conventional ceramic processing techniques such as tape casting, sintering, and screen-printing. However, conventional mixed-potential sensors are not used to sense ammonia.

Another conventional ammonia sensor splits a gas stream into two separate streams, treating each stream with a separate catalyst to oxidize the ammonia in one stream to nitric oxide (NO) and in the other stream to nitride (N₂). Each stream is subsequently passed over a separate NO_{X} sensor to provide two measurements. The difference between the two measurements is correlated to the concentration of ammonia in the exhaust gas. While it is feasible to split the gas stream into separate streams, doing so introduces complexity in the design that can result in higher cost.

### SUMMARY

Embodiments of a system are described. In one embodiment, the system is a sensing apparatus to measure ammonia in an exhaust gas mixture. An embodiment of the sensing system includes and ammonia sensing element and an electronic control module. The ammonia sensing element includes multiple electrode assemblies. The electrode assemblies generate a differential electrical signal based on corresponding first and second electrical signals in response to detection of the ammonia component of the exhaust gas mixture. The electronic control module is coupled to the ammonia sensor. The electronic control module is configured to convert the voltage differential to an ammonia measurement. Other embodiments of the system are also described.

Embodiments of an apparatus are also described. In one embodiment, the apparatus is a sensing apparatus to measure ammonia in a gas mixture. An embodiment of the sensing apparatus includes a sensing element, which includes a substrate, a first electrode assembly, and a second electrode assembly. The first electrode assembly includes a first sensor electrode coupled to the substrate. The first electrode assembly is configured to react to the ammonia in the gas mixture. The second electrode assembly includes a second sensor electrode coupled to the substrate. The second electrode assembly is configured to react to the ammonia in the gas mixture. The first and second electrode assemblies are configured to generate a differential electrical signal in response to the ammonia detected by the second electrode assembly. Electrical leads coupled to the first and second electrode assemblies to transmit a differential electrical signal from the first and second electrode assemblies. In some embodiments, the first and second sensor electrodes are substantially similar materials with substantially similar microstructures. In some embodiments, the first and second sensor electrodes are substantially similar materials with dissimilar microstructures. In some embodiments, the first and second sensor electrodes are dissimilar materials. Other embodiments of the sensor apparatus are also described.

Another embodiment of an apparatus is also described. In one embodiment, the apparatus includes means for generating a differential electrical signal in response to a first reaction involving the ammonia in the gas mixture and a second reaction involving the ammonia in the gas mixture, and means for determining an amount of ammonia in the gas mixture based on the differential electrical signal. The second reaction is dissimilar from the first reaction. Other embodiments of the apparatus are also described.

While each of described embodiments includes multiple electrode assemblies to generate a differential electrical signal, the implementation of the electrode assemblies may vary among the different embodiments. In some embodiments, the electrode assemblies have sensor electrodes that are fabricated from the same material and have the same microstructure. In other embodiments, the electrode assemblies have sensor electrodes that are fabricated from the same material, but have different microstructures. In other embodiments, the electrode assemblies are fabricated from different materials. Whether fabricated from the same or different materials, the sensor electrodes of the electrode assemblies are dissimilar in that they each react differently with respect to various ammonia concentrations. These dissimilar reactions produce measurable differential electrical signals in the form of a differential voltage signal or a differential current signal.

Additionally, some embodiments of the system and apparatus may be implemented to measure ammonia in exhaust gas mixtures from mobile sources such as automobiles and trucks. Other embodiments may be implemented to measure ammonia in exhaust gas mixtures from stationary sources such as power plants.

Other aspects and advantages of embodiments of the present invention will become apparent from the following detailed description, taken in conjunction with the accompanying drawings, which are illustrated by way of example of the various principles and embodiments of the invention.

### BRIEF DESCRIPTION OF THE DRAWINGS

FIG. 1A illustrates a schematic perspective view of one embodiment of an ammonia sensor.

FIG. 1B illustrates a perspective cross-sectional view of the ammonia sensor of FIG. 1A.

FIG. 2A illustrates a schematic perspective view of another embodiment of an ammonia sensor.

FIG. 2B illustrates a perspective cross-sectional view of the ammonia sensor of FIG. 2A.

FIG. 3A illustrates a schematic perspective view of another embodiment of an ammonia sensor.

FIG. 3B illustrates a perspective cross-sectional view of the ammonia sensor of FIG. 3A.

FIG. 4 illustrates a signal diagram of an exemplary voltage response, as a function of time, of the ammonia sensor of FIG. 1A for sequentially increasing ammonia concentrations.

FIG. 5 illustrates a signal diagram of an exemplary voltage response, as a function of time, of the ammonia sensor of FIG. 2A for sequentially increasing ammonia concentrations.

FIG. 6 illustrates a signal diagram of an exemplary voltage response, as a function of time, of the ammonia sensor of FIG. 3A for sequentially increasing ammonia concentrations.

FIG. 7 illustrates a signal diagram of another exemplary voltage response, as a function of time, of the ammonia sensor of FIG. 2A for two different nitric oxide concentrations.

FIG. 8A illustrates a schematic perspective view of another embodiment of an ammonia sensor.

FIG. 8B illustrates a perspective cross-sectional view of the ammonia sensor of FIG. 8A.

FIG. 9A illustrates a schematic perspective view of another embodiment of an ammonia sensor.

FIG. 9B illustrates a perspective cross-sectional view of the ammonia sensor of FIG. 9A.

FIG. 10 illustrates an exploded ammonia sensor layout of an embodiment of an ammonia sensor.

FIG. 11 illustrates an exploded ammonia sensor layout of another embodiment of an ammonia sensor.

FIG. 12 illustrates an exploded ammonia sensor layout of another embodiment of an ammonia sensor.

FIG. 13 illustrates a perspective sectional view of an embodiment of a packaged ammonia sensor.

FIG. 14 illustrates a schematic block diagram of an embodiment of a sensing system for use with an exhaust system.

Throughout the description, similar reference numbers may be used to identify similar elements.

### DETAILED DESCRIPTION

In the following description, specific details of various embodiments are provided. However, some embodiments may be practiced without at least some of these specific details. In other instances, certain methods, procedures, components, and circuits are not described in detail for the sake of brevity and clarity.

In general, the described embodiments are directed to a method and design for measuring ammonia (NH₃) gas in exhaust streams such as, without limitation, mobile exhaust sources (including automobiles and trucks) and stationary exhaust sources (including power plants). The ammonia gas sensors may be used at high temperatures for measuring total ammonia concentration in a gas mixture. Throughout this specification, “sensors” may be used interchangeably with “sensing apparatus.” Moreover, embodiments of the ammonia sensor detect residue of gaseous ammonia or urea that is added, in some instances, to such exhaust streams to mitigate NO_{X} emissions in processes such as selective catalytic reduction (SCR).

In some embodiments, the ammonia gas sensor includes two electrodes on a substrate. The substrate may be a flat surface of a planar structure, a curved surface of a tube, or some other complex shaped structure. The two electrodes could be on the same surface or on different surfaces of the substrate.

In some embodiments, the electrodes are dissimilar electrodes, so that the ammonia in the exhaust gas reacts differently on each of the electrodes. The dissimilar nature of the electrodes can be achieved in a variety of ways, including: (1) electrodes with different chemical compositions; (2) electrodes with different physical characteristics (e.g., geometrical area, thickness, surface area, microstructure, density); and (3) electrodes with different coatings applied to them to change the nature or extent of specific ammonia oxidation reactions that occur on or in proximity to the electrodes. The electrodes themselves may be thin layers that are processed through a variety of methods such as screen-printing, pad-printing, sputtering, electron-beam deposition, pulsed laser deposition, chemical vapor deposition, or any other process that is generally known to be used for thin or thick film fabrication. Alternatively, the electrodes may be pre-fabricated layers, mats, meshes, pads, contacts, or wires. In some embodiments, the sensors are capable of measuring ammonia concentration as low as 1 part per million (ppm) and changes in ammonia concentration as low as 1 ppm. In another embodiment the sensors are capable of detecting ammonia levels as low as 10 parts per billion (ppb) and changes in ammonia concentration as low as 10 ppb.

In some embodiments, the ammonia concentration is directly correlated with the electrical potential measured between the two dissimilar electrodes, which are exposed to the target gas. The electrodes may be operated at the same temperature or, in some embodiments, at different temperatures.

Other embodiments involve measuring at least two different potentials. For example, the individual potentials between a “reference electrode” and each of two dissimilar electrodes on the surface can be measured. Exemplary reference electrodes include a sealed air reference electrode, a metal/metal-oxide embedded electrode, an air reference electrode, or another type of reference electrode. The two potentials in combination can be used to determine the ammonia concentration in the target gas.

In some embodiments, the substrate is an ion-conducting material. In some embodiments, the substrate consists of or predominantly consists of an ion-conducting material. For example, the substrate may consist of or predominantly consist of an oxygen ion-conducting material. Alternatively, the substrate may consist of or predominantly consist of a proton-conducting or a metal ion-conducting material.

In some embodiments the substrate is not an ion-conducting material. In particular, the substrate may consist of or predominantly consist of a material that is not an ion-conducting material. In such embodiments, the electrodes may be in contact with another porous coating, layer, or material that is, consists of, or predominantly consists of an ion-conducting material. For example, the electrodes may be in contact with a porous coating that is, consists of, or predominantly consists of an oxygen ion-conducting material. Alternatively, the electrodes may be in contact with a coating that is, consists of, or predominantly consists of a proton-conducting or a metal ion-conducting material.

Other embodiments of the sensor also incorporate a NO_{X} and/or an oxygen sensor or sensing element so that NO_{X} and oxygen concentrations can be measured simultaneously with ammonia. These measurements may allow the accurate determination of the total ammonia concentration based, at least in part, on a signal which is a function of the NO_{X} and oxygen concentrations.

In some embodiments, the ammonia sensor includes heaters to heat the electrodes to a temperature within an operating temperature range. Alternatively, the heaters may heat the electrodes to dissimilar operating temperatures. In some embodiments, the operating temperatures of the electrodes are maintained by the use of one or more temperature measuring devices as part of a feedback control mechanism with the heaters. Exemplary temperature measurement devices include wire thermocouples, thin or thick film thermocouples, resistors, a resistance temperature detector (RTD), or another type of temperature measurement device.

Some embodiments of the ammonia sensor are adapted for use in exhaust environments. Furthermore, some embodiments are implemented to reduce cross-sensitivities to other gas species such as carbon monoxide (CO), hydrocarbons, sulfur dioxide, and other gas species present in exhaust gases. For example, to reduce cross-sensitivity to CO and/or hydrocarbons, specific oxidation catalysts may be used for separate gas preconditioning or as a coating on the surface of at least one of the electrodes. To reduce cross-sensitivity to sulfur dioxide, materials that absorb sulfur dioxide may be used as part of a separate preconditioning unit or as a coating on the surface of at least one of the electrodes. Other embodiments may reduce gas cross-sensitivities by using a bias voltage or a bias current applied between at least two of the electrodes.

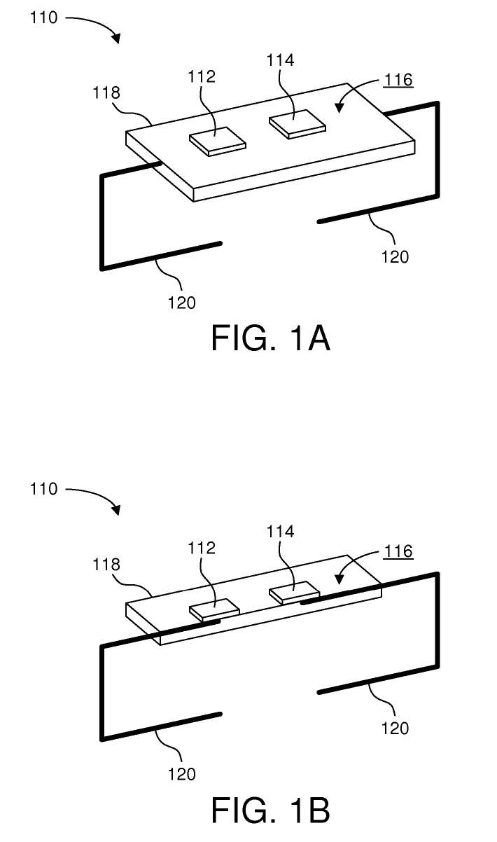

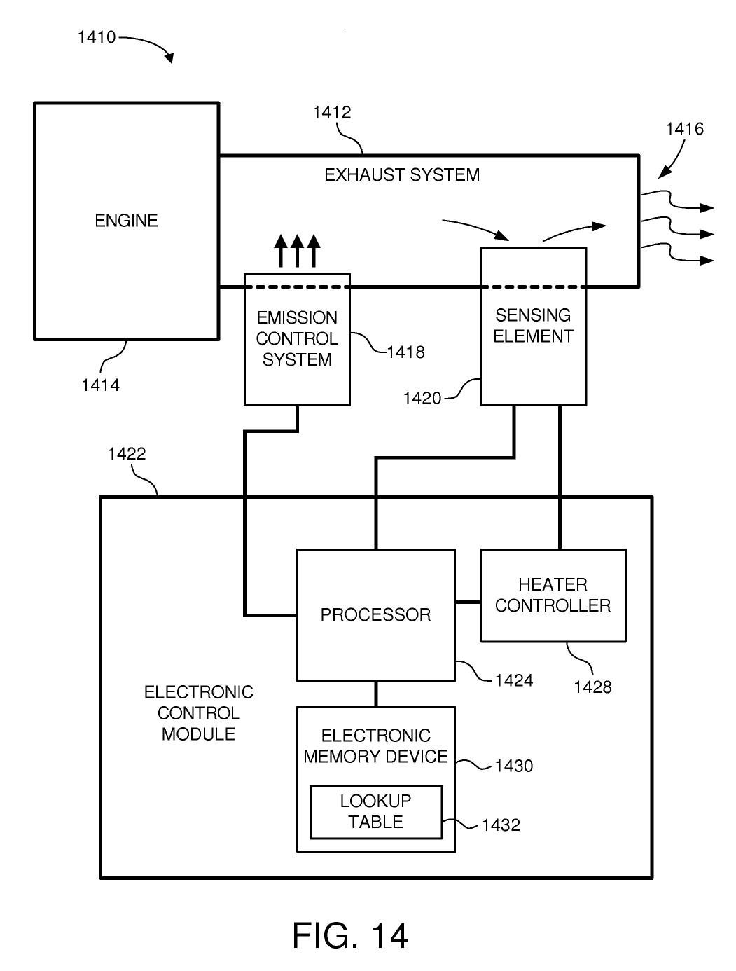

FIG. 1A illustrates a schematic perspective view of one embodiment of an ammonia sensor 110. FIG. 1B illustrates a perspective cross-sectional view of the ammonia sensor 110 of FIG. 1A. Embodiments of the ammonia gas sensor 110 are used to measure ammonia in a gas stream such as an exhaust stream. The illustrated ammonia sensor 110 includes multiple electrode assemblies, including a first sensor electrode 112 and a second sensor electrode 114 mounted to a surface 116 of a substrate 118. Each sensor electrode 112 and 114 generates an electrical signal such as a voltage potential. The electrical signal is carried by electrical leads 120 to a diagnostic device such as a volt meter (not shown) or an electronic control module (refer to FIG. 14). Embodiments of the electronic control module are also referred to as a data acquisition system.

It should be noted that references to electrode assemblies may include sensor electrodes, as well as one or more other layers or materials that are used in conjunction with the corresponding sensor electrodes. For example, one embodiment of an electrode assembly may include a single sensor electrode, without any other layers or materials. Another embodiment of an electrode assembly may include a sensor electrode with a single layer such as a catalyst applied to the sensor electrode. Another embodiment of an electrode assembly may include multiple layers, including exemplary layers such as an ion-conducting layer, multiple catalysts, an absorption layer, or some combination thereof. Other embodiments may include other layers.

Although the electrodes 112 and 114 are shown attached to the same surface 116 of the substrate 118, other embodiments may implement the electrodes 112 and 114 on opposite sides of the substrate 118. Additionally, the substrate 118 may be configured in a shape other than a substantially planar implementation. For example, the substrate 118 may be tubular or some other shape. Additionally, the locations of the electrodes 112 and 114 on the substrate 118 may be optimized to provide a significant interaction between the gas stream and each of the electrodes 112 and 114. In some embodiments, the electrodes 112 and 114 are attached to the substrate 118 by adhesion, press fitting, welding, fasteners, or another attachment mechanism.

The electrodes 112 and 114 may be fabricated of the same material and be positioned relative to each other such that an electrical potential difference can be measured across the first and second electrodes 112 and 114. In embodiments where there are more than two electrodes 112 and 114, the electrodes 112 and 114 are positioned relative to each other such that an electrical potential can be measured across the pair of electrodes 112 and 114. In one embodiment, the electrodes 112 and 114 may be made of noble metals. For example, the electrodes 112 and 114 may both include or consist entirely of platinum (Pt). In certain embodiments, the electrodes 112 and 114 may be conductive or semi-conductive.

In another embodiment, the electrodes 112 and 114 are fabricated of dissimilar materials. For example, the first electrode 112 may be predominantly platinum (Pt), and the second electrode 114 may be predominantly tungsten oxide (WO₃). In other embodiments, the electrodes 112 and 114 may be made of the same material but are dissimilar in their microstructures. For example, both electrodes 112 and 114 may be made of platinum, but may have different microstructures, densities, porosities, thicknesses, or other differences. These dissimilarities allow the electrodes 112 and 114 to react differently with ammonia that comes into contact with the electrodes 112 and 114. Accordingly, in one embodiment, references to dissimilar electrodes include electrodes that are structurally, physically, chemically, or functionally dissimilar in the way in which they react to ammonia. Hence, a variety of combinations of electrodes 112 and 114 may be used to generate an electrical potential across the electrodes 112 and 114.

In the embodiment, the substrate 118 on which the electrodes 112 and 114 are mounted is a thin substrate. Additionally, the substrate 118 may be fabricated of an ion-conducting material. In one embodiment, the substrate 118 is an oxygen ion-conducting material. In other embodiments, the substrate 118 is a hydrogen ion-conducting material. In another embodiment, the substrate 118 is an alkali ion-conducting material. For example, the substrate 118 may be a 6 mol % yttria stabilized zirconia (YSZ) substrate fabricated by tape casting.

The electrical connection leads 120 to the electrodes 112 and 114 may be screen-printed onto the surface 116 of the sintered YSZ tape. In one embodiment, the lead wires 120 are platinum. Other embodiments may use other materials for the electrical leads 120. In one embodiment, the electrical leads 120 are printed and fired at a temperature of 1200° C. Where dissimilar materials are used for the electrodes 112 and 114, a platinum electrode may be printed and fired at a temperature of 1000° C., and a tungsten oxide electrode may be printed and fired at a temperature of 925° C.

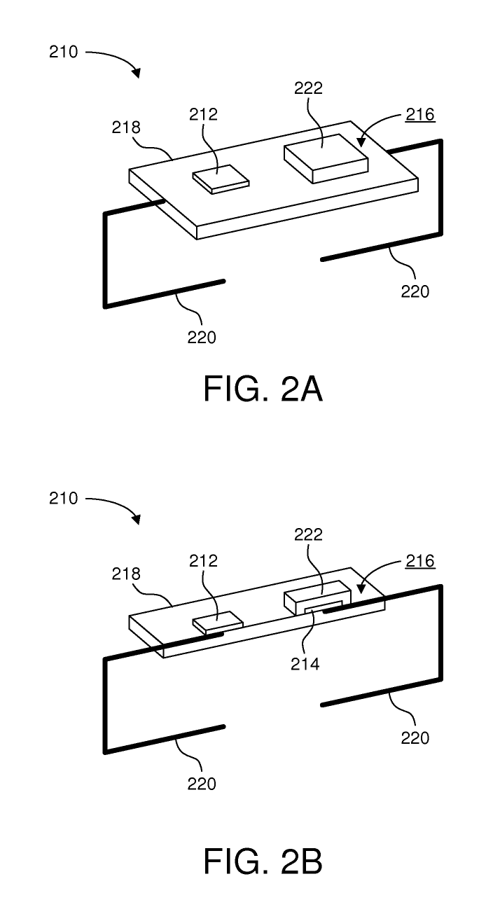

FIG. 2A illustrates a schematic perspective view of another embodiment of an ammonia sensor 210. FIG. 2B illustrates a perspective cross-sectional view of the ammonia sensor 210 of FIG. 2A. The illustrated ammonia sensor 210 includes multiple electrode assemblies. In particular, the first electrode assembly includes a first sensor electrode 212, and the second electrode assembly includes a second sensor electrode 214. Both of the sensor electrodes are coupled to a surface 216 of a substrate 218. Similar to the ammonia sensor 110 of FIGS. 1A and 1B, the ammonia sensor 210 of FIGS. 2A and 2B also includes electrical leads 220 coupled to each of the electrode assemblies and, in particular, to the sensor electrodes 212 and 214 of each electrode assembly.

In the illustrated ammonia sensor 210, a layer 222 substantially covers the sensor electrode 214, while the other sensor electrode 212 is not covered. It should be noted that references to a substantial covering may indicate that a majority of the surface area of the sensor electrode 214 is covered by the layer 222. Alternatively, references to a substantial covering may mean that ammonia or other gas comes into contact with the layer 222 before, or simultaneously with, coming into contact with the sensor electrode 214 that is substantially covered by the layer 222.

In one embodiment, the layer 222 is a catalyst material. For example, the layer 222 may include a catalyst material that is an oxide such as ruthenium oxide (RuO₂) or another material based on ruthenium oxide. In one embodiment, one of the electrodes 212 and 214 may be coated with a RuO₂-infiltrated alumina pad. The RuO₂-infiltrated catalyst layer may be fabricated by infiltration of an alumina felt pad with ruthenium chloride (RuCl₂) solution followed by firing the pad at 680° C. to oxidize the RuCl₂ to RuO₂. The RuO₂-infiltrated alumina pad may be bonded with ceramic cement or attached in other ways to the surface 216 of the substrate 218 so as to partially or fully cover one of the electrodes 212 and 214.

In another embodiment, the layer 222 may be any non-zeolite oxide. In other embodiments, the layer 222 may substantially cover both electrodes 212 and 214. At each electrode 212 and 214, the layer 222 may include the same catalyst material or different catalyst materials. As discussed in greater detail below, multiple layers 222 may be applied to or interact with either or both electrodes 212 and 214.

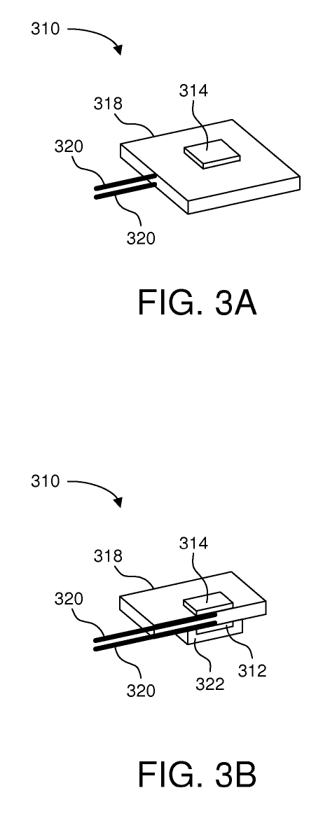

FIG. 3A illustrates a schematic perspective view of another embodiment of an ammonia sensor 310. FIG. 3B illustrates a perspective cross-sectional view of the ammonia sensor 310 of FIG. 3A. The illustrated ammonia sensor 310 is substantially similar to the ammonia sensor 210 of FIGS. 2A and 2B, except that the sensor electrodes 312 and 314 are located on opposite sides of the substrate 318. One of the electrodes 312 includes an additional layer 322 such as a catalyst layer. In one embodiment, the substrate 318 is a thin substrate of a 6 mol % yttria stabilized zirconia (YSZ). Other embodiments may use other types of substrates 318. Electrical connection leads 320 are attached to the electrodes 312 and 314 and may be screen-printed onto the surface of the sintered YSZ electrolyte substrate 318.

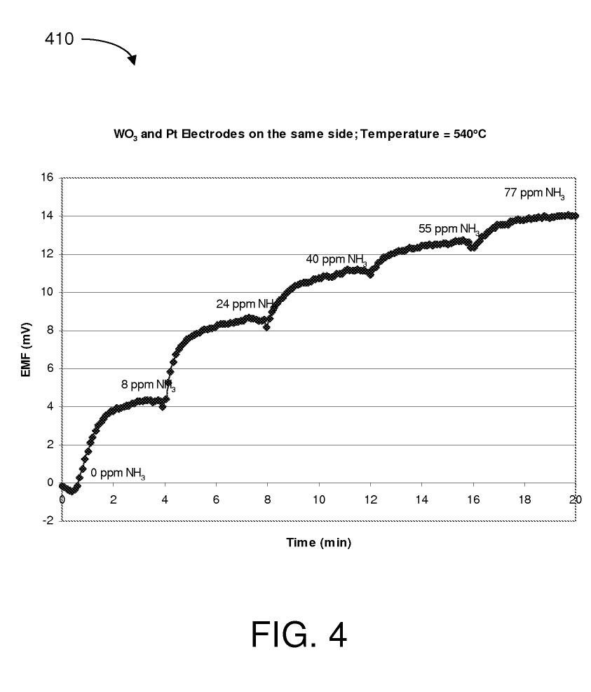

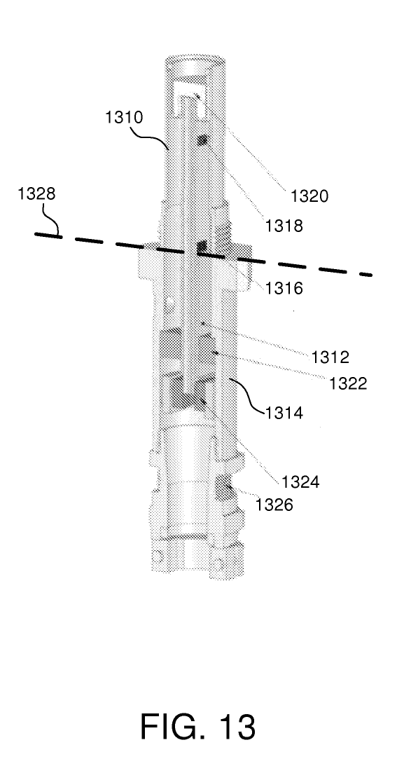

FIG. 4 illustrates a signal diagram 410 of an exemplary voltage response, as a function of time, of the ammonia sensor 110 of FIG. 1A for sequentially increasing ammonia concentrations. In order to generate the signal diagram 410 of the exemplary voltage response, an embodiment of the ammonia sensor 110 was fabricated. The fabricated ammonia sensor 110 included sensor electrodes 112 and 114 attached to separate alumina substrates 118 containing screen-printed platinum heaters. A thermocouple was also installed in proximity to the sensor electrodes 112 and 114. Platinum stripes attached to the sensor electrodes 112 and 114 were connected to lead wires 120 which were in turn connected to a computer-based data acquisition system. The ammonia sensor 110 was enclosed in a small tubular metal housing having approximate dimensions of 3.0″×0.75″ (refer to FIG. 13). The wires from each heater were connected to a direct current (DC) power supply, which supplied power to the heaters to heat the sensor electrodes 112 and 114 to an operating temperature of approximately 540° C.

An experimental gas mixture was then introduced into the housing containing the ammonia sensor 110. The gas mixing system used 4 MKS mass flow controllers for mixing and controlling the flow of various gas compositions. The gas mixture consisted of between 0-77 ppm of ammonia, 5% oxygen (O₂), and the balance nitrogen (N₂). The voltage response of the ammonia sensor 110 is dependent on the various ammonia concentrations (incremented every 4 seconds). As can be seen, the results indicate that when ammonia concentration in the gas that passes through the housing changes to a new level, the ammonia sensor 110 shows a corresponding change in the output voltage (i.e., the sensor response). Hence, the ammonia sensor can be used to measure ammonia levels in target gases by correlating the generated sensor response to a value for a corresponding ammonia quantity.

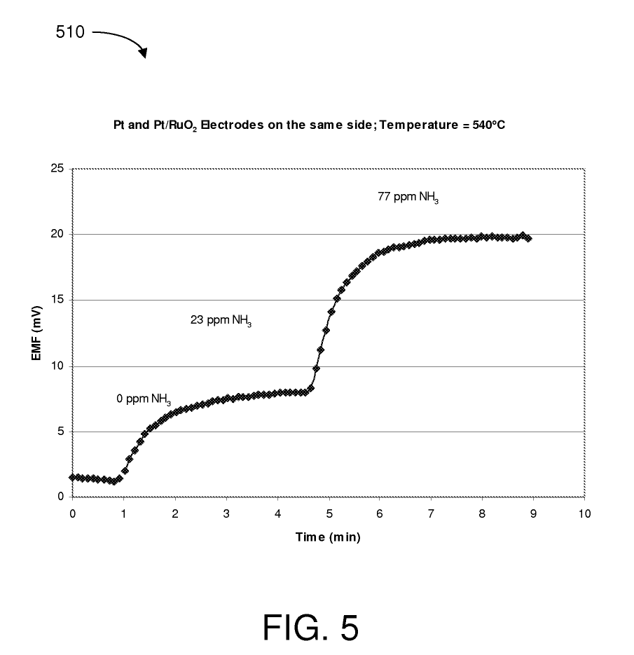

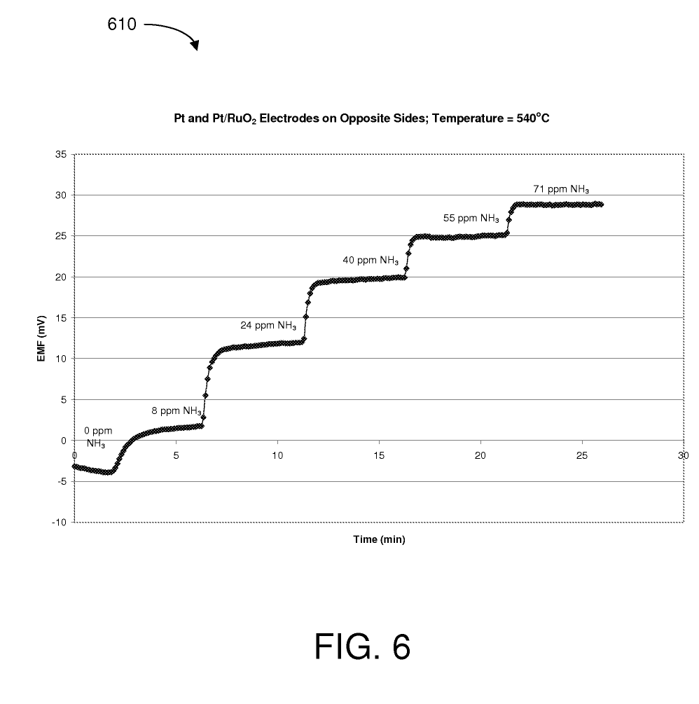

FIG. 5 illustrates a signal diagram 510 of an exemplary voltage response, as a function of time, of the ammonia sensor 210 of FIG. 2A for sequentially increasing ammonia concentrations. FIG. 6 illustrates a signal diagram 610 of an exemplary voltage response, as a function of time, of the ammonia sensor 310 of FIG. 3A for sequentially increasing ammonia concentrations.

An additional feature of embodiments of the ammonia sensors 110, 210, and 310 is the ability to minimize cross-sensitivity to other gases that may be present in exhaust gases. Exemplary gases include oxides of nitrogen (collectively called NO_{X}), hydrocarbons, carbon monoxide (CO), carbon dioxide (CO₂), and steam (H₂O). Embodiments of the ammonia sensors 110, 210, and 310 can be implemented to have a low cross-sensitivity to each of these gases, either through modifications to the configurations of the ammonia sensors 110, 210, and 310 or through adding additional features to the design of the sensing element, specifically, or the sensing system, generally. For example, some embodiments catalysts to oxidize or absorb one or more materials such as hydrocarbons, NO_{X}, CO, CO₂, H₂O, SO₂, and other materials.

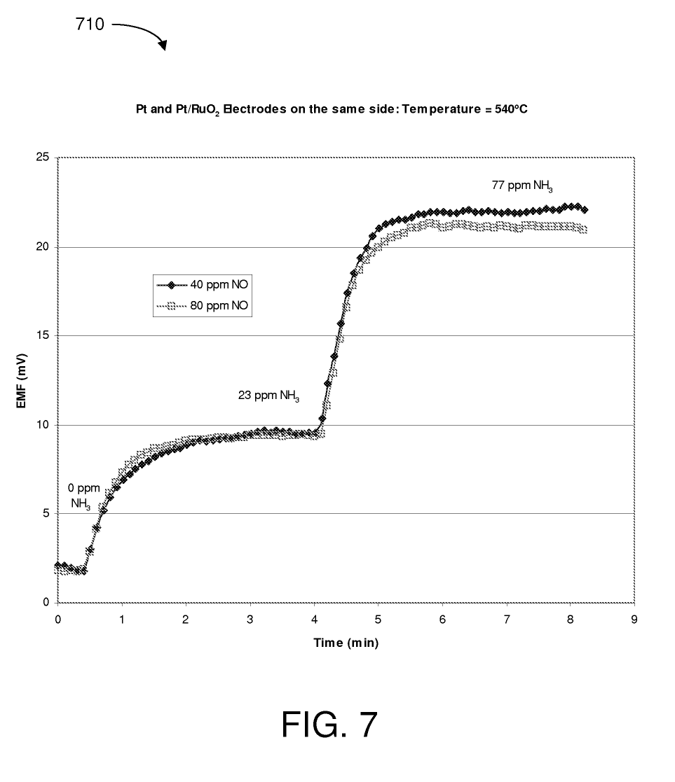

FIG. 7 illustrates a signal diagram 710 of another exemplary voltage response, as a function of time, of the ammonia sensor 210 of FIG. 2A for two different nitric oxide (NO) concentrations. As described above, the ammonia sensor 210 was coupled with a heater, thermocouple, and housing. Concentrations of ammonia and nitric oxide were varied in a gas mixture containing 5% oxygen and the balance nitrogen (N₂). The results of the experiment show that the signal strengths and responses to different levels of ammonia are relatively unchanged at two different concentrations of nitric oxide. This indicates a low cross-sensitivity to nitric oxide, which is the primary constituent of NO_{X}. In some embodiments, the cross-sensitivity to NO_{X} can be effectively reduced or minimized by selecting an appropriate temperature range for the electrodes 212 and 214.

In some embodiments, the cross-sensitivity to other gases such as CO and hydrocarbons may be reduced by specific use of oxidation catalyst materials. For example, by using the same oxidation catalyst on each electrode that will oxidize CO and hydrocarbons before they can permeate to the electrode/electrolyte interface, the cross-sensitivity to CO and hydrocarbons may be reduced or mitigated. Exemplary oxidation catalysts include nickel aluminate (NiAl₂O₄), vanadium pentoxide (V₂O₅), Molybdenum Oxide (MoO₃), tungsten oxide (WO₃), iron oxide (FeO, Fe₂O₃, Fe₃O₄), cerium oxide (CeO₂), copper oxide (CuO), manganese oxide (MnO₂), ruthenium oxide (RuO₂), silver (Ag), platinum (Pt) and copper(Cu), as well as various mixtures and composites containing these oxygen catalysts. Other embodiments may use other catalysts to oxidize CO and hydrocarbons. Additionally, the ammonia sensor 210 can be made sensitive to ammonia by masking the dissimilar electrodes. Thus, an additional layer 222 that favors a different ammonia oxidation reaction may be used in some embodiments of the ammonia sensor 210.

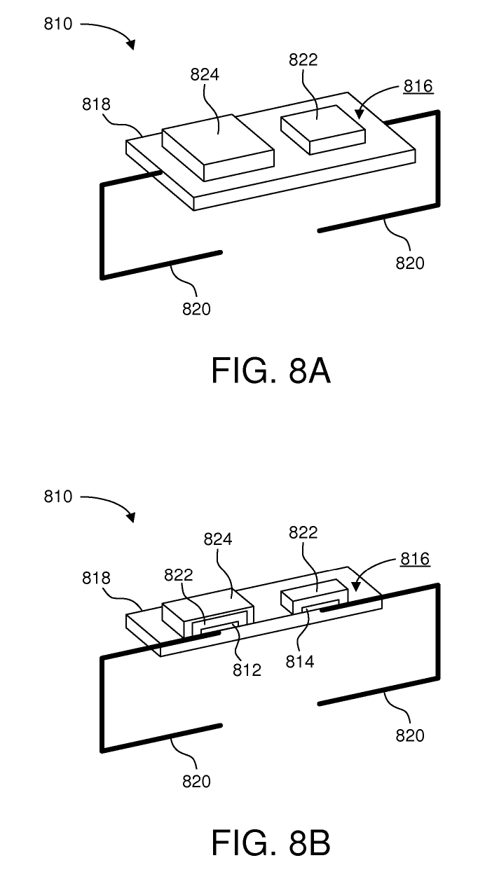

FIG. 8A illustrates a schematic perspective view of another embodiment of an ammonia sensor 810. FIG. 8B illustrates a perspective cross-sectional view of the ammonia sensor 810 of FIG. 8A. The illustrated ammonia sensor 810 includes multiple electrode assemblies attached to a surface 816 of a substrate 818. The first electrode assembly includes a first sensor electrode 812, a first layer 822, and a second layer 824. The second electrode assembly includes a second sensor electrode 814 and the first layer 822. In another embodiment, the layer 822 that covers the second sensor electrode 814 may different from the layer 822 that covers the first sensor electrode 812. Electrical leads 820 attached to the sensor electrodes 812 and 814 carry electrical signals from the corresponding sensor electrodes 812 and 814.

In one embodiment, the electrode assemblies are dissimilar in that they produce different electrical potential signals in response to the same ammonia concentration. In particular, the dissimilar responses may result from dissimilar sensor electrodes 812 and 814, or from similar sensor electrodes 812 and 814 coated with one or more different layers 822 and 824. In one embodiment, the sensor electrodes 812 and 814 are predominantly platinum (Pt), and the sensor electrode 812 is substantially covered by a layer 822 which includes catalyst material. In one embodiment, the catalyst material is a catalyst that can oxidize CO and hydrocarbons effectively to CO₂ and H₂O. The other electrode 814 may be substantially covered by a layer 822 that includes the same catalyst material, as well as an additional layer 824 that may include a different catalyst material than the first layer 822. The second layer 824 may include a catalyst material that is selective to oxidation of ammonia to nitrogen and steam. For example, in one embodiment, the layer 824 is nickel aluminate. Other embodiments may use other layers 822 and 824 or may use fewer or more layers on at least in of the sensor assemblies.

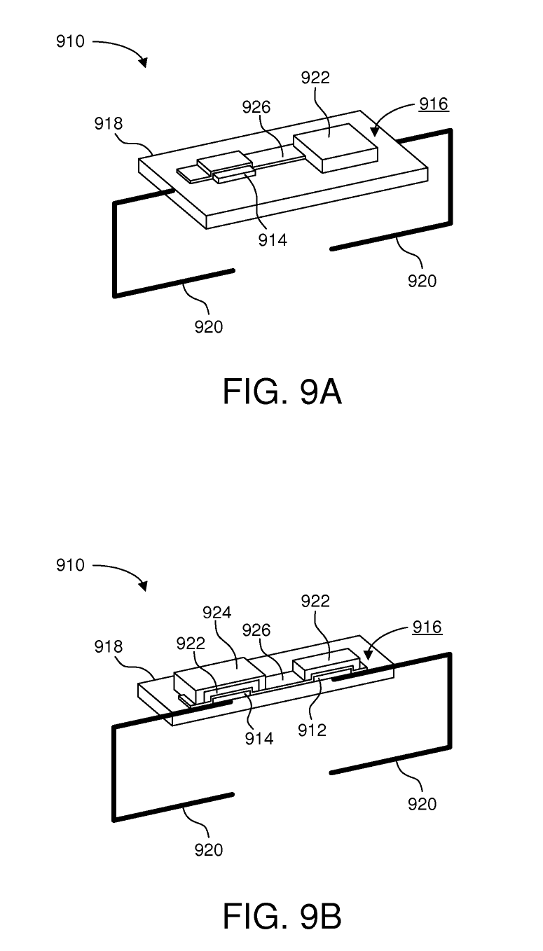

FIG. 9A illustrates a schematic perspective view of another embodiment of an ammonia sensor 910. FIG. 9B illustrates a perspective cross-sectional view of the ammonia sensor 910 of FIG. 9A. The illustrated ammonia sensor 910 includes two electrode assemblies attached to the surface 916 of the substrate 918. However, for convenience in describing the various layers of the electrode assemblies, FIG. 9A omits some of layers 922 and 924 applied to the sensor electrode 914.

In one embodiment, the substrate 918 of the ammonia assembly 910 is not ionically conductive. However, a coating 926 of an ionically conductive material may cover at least a portion of one or both sensor electrodes 912 and 914. The coating 926 may also cover a portion of at least two electrodes. The coating 926 may be applied or attached to the electrodes 912 and 914 in any of a number of suitable ways, including fasteners, bonding, welding, press fitting, adhesion, and so forth. In one embodiment, the coating is between the layer 922 and the electrodes 912 and 914. In one embodiment, the coating 926 includes yttria stabilized zirconia (YSZ). Other embodiments of the ammonia sensor 910 may include other types of coatings 926.

It should be noted that other embodiments of the ammonia sensors described above may be implemented in conjunction with a sulfur absorption material or a filter containing desulfurizing material. The filter may be a sulfur scrubber for removing sulfur from a gas stream prior to the gas stream coming into contact with a sensor electrode. Additionally, some embodiments of the ammonia sensors may include or be coupled with a heater and, optionally, a temperature measurement and control system so as to maintain the temperature of at least one of the electrodes at a determined operating temperature.

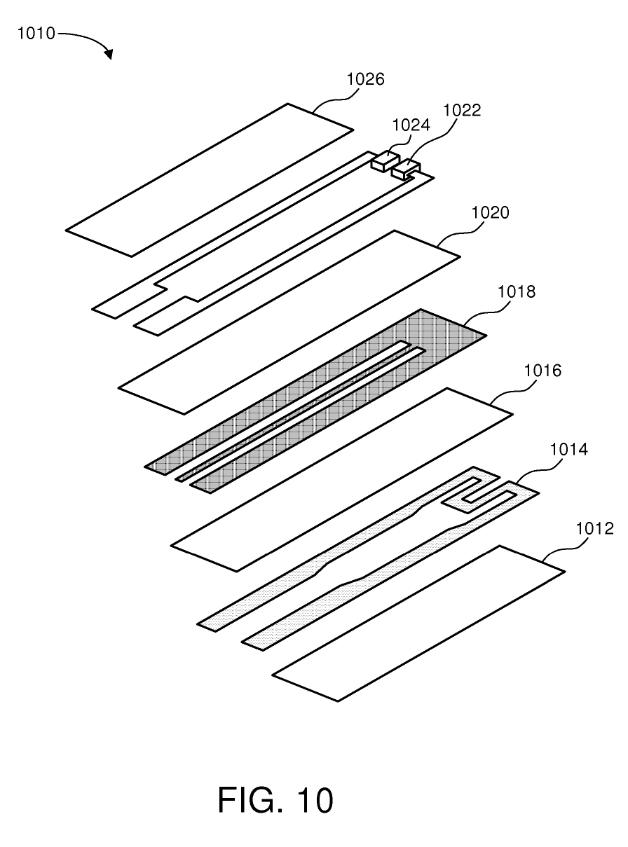

FIG. 10 illustrates an exploded ammonia sensor layout of an embodiment of an ammonia sensor 1010. The illustrated ammonia sensor 1010 includes a bottom cover plate 1012, a heater layer 1014, a heater substrate 1016, a thermocouple channel layer 1018, an ion-conducting substrate 1020, an electrode assembly layer with multiple electrode assemblies 1022 and 1024, and a top cover plate 1026. In one embodiment, the bottom cover plate 1012 and the top cover plate 1026 are fabricated of alumina. Similarly, the heater substrate 1016 and the thermocouple channel 1018 may be fabricated of alumina. In one embodiment, the ion-conducting substrate 1020 is fabricated of YSZ. The electrode assemblies 1022 and 1024 may include sensor electrodes, as well as one or more additional layers, as described above.

As one exemplary embodiment, the ammonia sensor 1010 includes a substrate 1020 fabricated of zirconia electrolyte, with the two dissimilar electrode assemblies 1022 and 1024 on the same side of the substrate 1020. The substrate 1020 is coupled with the heater layer 1014 and the thermocouple layer 1018. The heater layer 1014 is fabricated by screen-printing a platinum resistor onto the alumina substrate 1016 and fired to 1000° C. After the fired pattern has cooled, additional layers of platinum (e.g., second and third layers) are screen printed on the leg portions of the heater pattern. The heater layer 1014 is then fired to 1200° C. and cooled. The alumina cover plate 1012 and the thermocouple channel layer 1018 are glass-bonded to the alumina substrate 1016 with the heater pattern 1014. The cover plate 1012 is glassed to the heater 1014 on the heater pattern side and covering the coil. The thermocouple channel layer 1018 is glassed to the side of the alumina substrate 1016 opposite the heater pattern 1014 with the channel orientation opening away from the coil of the heater. A thermocouple is then inserted into the thermocouple channel and held in place with a small amount of silver (Ag) ink placed in the thermocouple channel. An additional small amount of silver ink is applied to the top of the thermocouple channel legs, and the YSZ substrate 1020 is placed onto the thermocouple channel layer 1018. The assembly is then fired to 750° C. to form the bond between the layers. It should be noted that the exemplary fabrication methods and geometry illustrated in FIG. 10 and described above in no way limits the methods by which the heater and temperature measurement may be utilized.

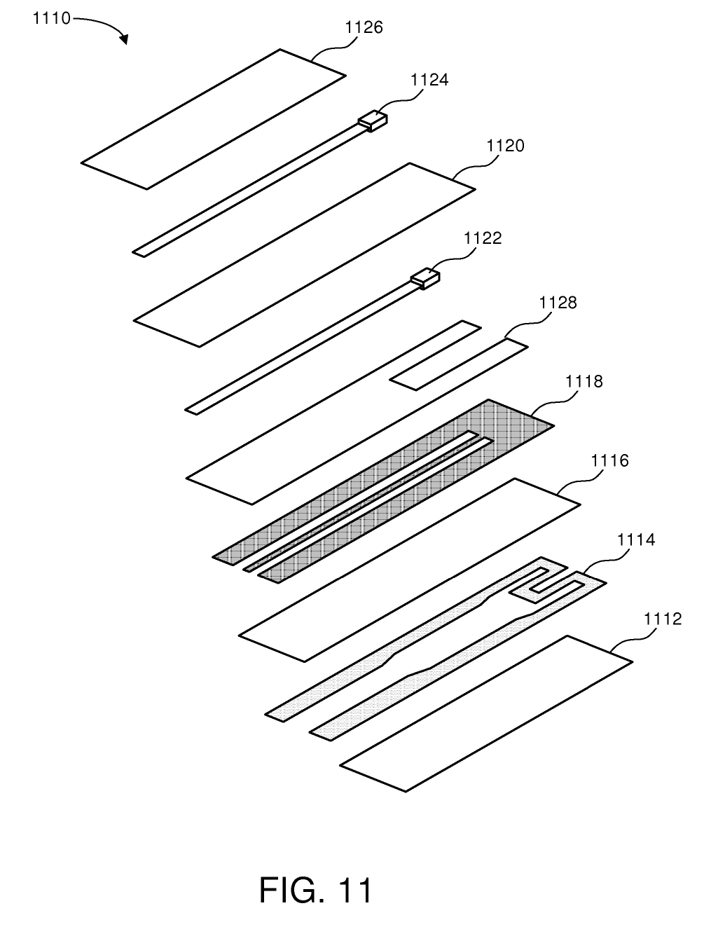

FIG. 11 illustrates an exploded ammonia sensor layout of another embodiment of an ammonia sensor 1110. The illustrated ammonia sensor 1110 includes a bottom cover plate 1112, a heater layer 1114, a heater substrate 1116, a thermocouple channel layer 1118, an ion-conducting substrate 1120, electrode assembly layers with electrode assemblies 1122 and 1124 on either side of the ion-conducting substrate 1120, and a top cover plate 1126. Since the electrode assemblies 1122 and 1124 are on both sides of the ion-conducting substrate 1120, the ammonia sensor 1110 also includes a gas channel layer 1128 to allow at least some of the gas stream to access the electrode assembly 1122 on the back side of the ion-conducting substrate 1120.

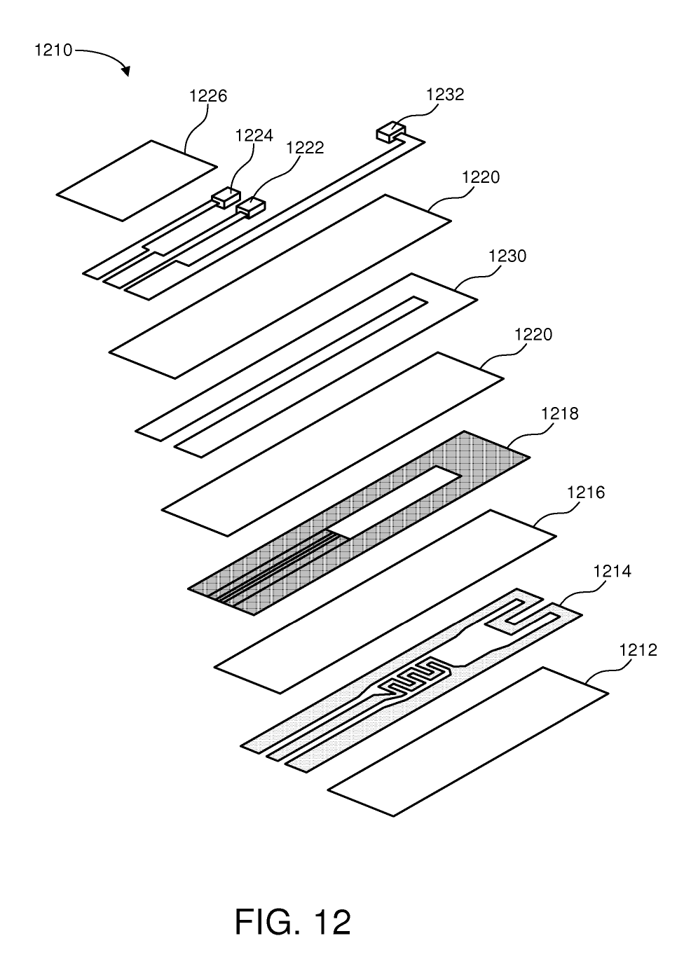

FIG. 12 illustrates an exploded ammonia sensor layout of another embodiment of an ammonia sensor 1210. The illustrated ammonia sensor 1210 includes a bottom cover plate 1212, a heater layer 1214, a heater substrate 1216, a thermocouple channel layer 1218, ion-conducting substrates 1220 on either side of an air reference channel layer 1230, an electrode assembly layer with multiple electrode assemblies 1222, 1224, and 1232, and a top cover plate 1226.

Since mixed potential sensors are generally known to be sensitive to oxygen, one way of overcoming this issue is to couple the electrode/electrolyte assembly with an oxygen sensor 1232. By measuring the signal from the oxygen sensor 1232, the oxygen concentration in the gas can be determined. By providing the signal to an electronic control module, the ammonia sensor 1210 can process the signals to determine the oxygen and ammonia levels in the target gas. This combination can be accomplished either by coupling with an external oxygen sensor (not shown) or the oxygen sensor 1232 that is built into the same multilayer assembly as the substrate which has the dissimilar electrodes 1222 and 1224.

As described above, some embodiments of the ammonia sensor 1210 may be used in combination with a desulfurizing component to treat or absorb sulfur containing compounds. This desulfurization stage of the ammonia sensor 1210 may include an absorbent material (also known as a sulfur scrubber) such as CaO, MgO, or a compound from the perovskite group of materials that serves the function of removing sulfur dioxide (SO₂) from the gas stream. This could be in the form of a packed pellet, electrode coating, or infiltrated support. Other embodiments may use other sulfur absorption or treatment mechanisms.

FIG. 13 illustrates a perspective sectional view of an embodiment of a packaged ammonia sensor 1310. In one embodiment, an ammonia sensor 1312 such as one of the ammonia sensors described above is placed within a housing 1314. The housing 1314 may be a metal housing or another type of housing. While different types of ammonia sensors may be used in the packaged ammonia sensor 1310, the illustrated ammonia sensor 1310 includes one or more ammonia electrode assemblies 1316 and an oxygen electrode assembly 1318. The packaged ammonia sensor 1310 also includes a sulfur scrubber 1320, a seal 1322, and one or more electrical connection points 1324. In one embodiment, the housing 1314 also incorporates a strain relief connector 1326.

In order to use the packaged ammonia sensor 1310 in an exhaust environment, the sensor end (designated as the portion above the dashed line 1328) of the packaged ammonia sensor 1310 is inserted, for example, into an exhaust pipe or other exhaust chamber that facilitates flow of the exhaust gas. The remaining portion (below the dashed line 1328) of the packaged ammonia sensor 1310 may extend out of the exhaust pipe or chamber to facilitate electrical connection to the ammonia sensor 1312 within the housing 1314. Other embodiments may be implemented in other ways.

FIG. 14 illustrates a schematic block diagram of an embodiment of a sensing system 1410 for use with an exhaust system 1412. In one embodiment, the exhaust system 1412 is connected to an engine 1414. The engine 1414 produces exhaust gases, and the exhaust system 1412 facilitates flow of the exhaust gases to an exhaust outlet 1416.

In order to reduce the amount of NO_{X} emissions from the engine 1414, an emission control system 1418 may inject gaseous ammonia or urea into the exhaust system 1412. In some embodiments, the emission control system 1418 includes an ammonia injector to inject the gaseous ammonia or urea into the exhaust system 1412. The gaseous ammonia or urea reacts with the NO_{X} to reduce the amount of NO_{X} in the exhaust gases. However, if too much gaseous ammonia or urea is injected into the exhaust stream, then some ammonia may be emitted from of the exhaust system 1412. In order to limit the amount of ammonia emitted from the exhaust system 1412, an ammonia sensing element 1420 detects ammonia in the exhaust stream. In one embodiment, the depicted ammonia sensing element 1420 is representative of one of the ammonia sensors described above. Alternatively, the ammonia sensing element 1420 may be representative of another type of ammonia sensor.

The ammonia sensing element 1420 then communicates one or more electrical signals to an electronic control module 1422. In one embodiment, the electronic control module 1422 is mounted remotely from the ammonia sensing element 1420. The ammonia sensing element 1420 may communicate the electrical signals to the electronic control module 1422 using any type of data signal, including wireless and wired data transmission signals. The illustrated electronic control module 1422 includes a processor 1424, a heater controller 1428, and an electronic memory device 1430.

In one embodiment, the processor 1424 facilitates execution of one or more operations of the data acquisition system 1422. In particular, the processor 1422 may execute instructions stored locally on the processor 1424 or stored on the electronic memory device 1430. Additionally, various types of processors 1424, include general data processors, application specific processors, multi-core processors, and so forth, may be used in the electronic control module 1422.

In one embodiment, emission control system 1418 also includes an ammonia controller to control the amount of gaseous ammonia or urea that is injected into the exhaust stream by the ammonia injector 1418. Similarly, the heater controller 1428 controls the heater or heaters in the ammonia sensing element 1420 to maintain specific operating temperatures for the corresponding electrode assemblies and, in particular, the corresponding sensor electrodes.

In one embodiment, the electronic memory device 1430 stores at least one lookup table 1432 to correlate a differential electrical signal from the ammonia sensor 1420 to a specified ammonia level or quantity. In this way, the processor 1424 can determine the amount of ammonia in the exhaust stream and, subsequently, make appropriate adjustments to either increase or decrease the amount of gaseous ammonia or urea that the emission control system 1418 injects into the exhaust stream.

Although the description provided above for the accompanying figures provides many specific details of embodiments and uses of ammonia sensing elements, other embodiments may be implemented and/or used in alternative ways. While the following description is not exhaustive of the various possible configurations of an ammonia sensing element consistent with the embodiments described above, the following description provides some alternative embodiments for an ammonia sensing elements with dissimilar electrodes.

In some embodiments, the ammonia sensing element includes at least two electrodes exposed to a gas mixture, where at least one of the electrodes is coated with a catalytically active material that favor the selective oxidation of ammonia or urea to N₂ and H₂O. The other electrode is coated with a catalytically active material that favor the selective oxidation of ammonia or urea to NO and H₂O. In other words, each sensor electrode has at least one coating. Hence, the measurements of N₂ and NO can be used to measure ammonia or urea in the gas mixture.

In another embodiment, one of the electrodes is coated with a catalytically active material that favors the selective oxidation of ammonia or urea to NO and H₂O, and is additionally coated with a catalytically active material that favors the selective oxidation of ammonia or urea to N₂ and H₂O. In other words, at least one sensor electrode has two or more coatings.

In another embodiment, one of the electrodes is coated with a catalytically active material that favors the selective oxidation of ammonia or urea to N₂ and H₂O. The other electrode is coated with a catalytically inactive material or a material with very low catalytic activity.

In another embodiment, one of the electrodes is coated with a catalytically active material that favors the selective oxidation of ammonia or urea to NO and H₂O. The other electrode is coated at least with a catalytically inactive material or a material with very low catalytic activity.

In some embodiments, the ammonia sensing element includes electrodes that are on the surface of an ion-conducting material. In some embodiments, the ion conducting material is an oxygen ion-conducting material, a hydrogen ion-conducting (i.e., proton-conducting) material, or an alkali metal (e.g. Li⁺, Na⁺, K⁺) ion-conducting material. In some embodiments, at least one of the electrodes contains a noble metal such as platinum, gold, or silver. In some embodiments, at least one of the electrodes contains a metal oxide such as tungsten oxide, molybdenum oxide, or copper oxide. In some embodiments, a bias current or voltage is applied between the electrodes.

In some embodiments, a porous or dense layer that includes an ion-conducting material at least partially covers at least one of the electrodes. In some embodiments, a porous or dense layer that includes an ion-conducting material at least partially covers at least one of the electrodes. In some embodiments, the porous or dense layer of ion-conducting material that partially covers at least one of the electrodes may be an oxygen ion-conducting material, a hydrogen ion-conducting (i.e., proton-conducting) material or an alkali metal (e.g. Li⁺, Na⁺, K⁺) ion-conducting material. In some embodiments, a sulfur absorbing or adsorbing at least partially removes sulfur dioxide in the gas stream before the gas comes in contact with at least one of the electrodes.

Additionally, an exemplary method for using at least one embodiment of the ammonia sensing element includes: providing an ammonia sensing element having at least two dissimilar electrodes that interact differently with ammonia; exposing the sensing element to an exhaust gas such that some ammonia in the exhaust gas will oxidize on at least one of the electrodes; generating an electrical potential between at least two of the electrodes; measuring the potential across the electrodes; estimating the oxygen content of the gas using an internal or external oxygen sensing element; calculating the amount of ammonia in the exhaust gas based on the measured electrical potential and the oxygen content by comparing with previously calibrated data, or by using a theoretical or empirical sets of equations, or by interpolation, extrapolation, or calculation based on calibrated data; and outputting a calculated amount of ammonia to a display or providing such information to an on-board computer or equivalent device.

Reference throughout this specification to “one embodiment,” “an embodiment,” or similar language means that the described feature, operation, structure, or characteristic may be implemented in at least one embodiment. Thus, the phrases “in one embodiment,” “in an embodiment,” and similar phrases throughout this specification may, but do not necessarily, refer to the same embodiment.

Furthermore, the described features, operations, structures, or characteristics of the described embodiments may be combined in any suitable manner. Hence, the numerous details provided here, such as examples of electrode configurations, housing configurations, substrate configurations, channel configurations, catalyst configurations, and so forth, provide an understanding of several embodiments of the invention. However, some embodiments may be practiced without one or more of the specific details, or with other features operations, components, materials, and so forth. In other instances, well-known structures, materials, or operations are not shown or described in at least some of the figures for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A sensing system to measure ammonia in an exhaust gas mixture, the sensing system comprising:
an ammonia sensing element comprising first and second electrode assemblies, the first and second electrode assemblies to generate a differential electrical signal in response to detection of an ammonia component of the exhaust gas mixture; and
an electronic control module coupled to the ammonia sensing element, the electronic control module to convert the differential electrical signal to an ammonia measurement.

2. The sensing system of claim 1, further comprising an emission control system coupled to the electronic control module, the emission control system to determine an amount of the ammonia component to be injected into the exhaust gas mixture based on the ammonia measurement and to inject the determined amount of the ammonia component into the exhaust gas mixture according to the ammonia measurement.

3. The sensing system of claim 1, further comprising a heater controller coupled to the ammonia sensing element, the heater controller to control a heater within the ammonia sensing element to heat at least one of the first and second electrode assemblies to an operating temperature.

4. The sensing system of claim 1, the electronic control module comprising:
an electronic memory device to store a lookup table of a plurality of ammonia measurement values indexed by a corresponding plurality of differential electrical signal values; and
a processor coupled to the electronic memory device, the processor to reference the lookup table in the electronic memory device to determine the ammonia measurement.

5. The sensing system of claim 1, the electronic control module comprising an electronic memory device to store machine readable instructions that, when executed by a processor, cause the electronic control module to compute the ammonia measurement based on a value of the differential electrical signal.

6. The sensing system of claim 1, wherein the first electrode assembly comprises a first sensor electrode, and the second electrode assembly comprises a second sensor electrode, the first and second sensor electrodes comprising substantially similar materials and substantially similar microstructures.

7. The sensing system of claim 5, wherein the first and second sensor electrodes are configured to generate the differential electrical signal in response to different operating conditions for each of the first and second sensor electrodes.

8. The sensing system of claim 7, wherein the differential electrical signal depends on a first operating temperature of the first sensor electrode a second operating temperature of the second sensor electrode, wherein the second sensor electrode is different from the first operating temperature.

9. The sensing system of claim 5, wherein the first sensor electrode comprises at least one physical dimension that is different from a corresponding physical dimension of the second sensor electrode, wherein the physical dimensions of the first and second sensor electrodes comprise different areas or different thicknesses.

10. The sensing system of claim 1, wherein the first electrode assembly comprises a first sensor electrode, and the second electrode assembly comprises a second sensor electrode, the first and second sensor electrodes comprising substantially similar materials and dissimilar microstructures.

11. The sensing system of claim 1, wherein the first electrode assembly comprises a first sensor electrode, and the second electrode assembly comprises a second sensor electrode, the first and second sensor electrodes comprising dissimilar materials.

12. The sensing system of claim 11, wherein at least one sensor electrode of the first and second sensor electrodes comprises a noble metal.

13. The sensing system of claim 11, wherein at least one sensor electrode of the first and second sensor electrodes comprises a metal oxide.

14. The sensing system of claim 11, wherein at least one electrode assembly of the first and second electrode assemblies comprises a catalyst disposed relative to the corresponding sensor electrode, the catalyst comprising a catalytically active material to selectively oxidize at least some of the ammonia to an oxide of nitrogen, wherein the corresponding sensor electrode is configured to detect the oxide of nitrogen.

15. The sensing system of claim 11, wherein at least one electrode assembly of the first and second electrode assemblies comprises a catalyst disposed relative to the corresponding sensor electrode, the catalyst comprising a catalytically active material to selectively oxidize at least some of the ammonia to nitrogen, wherein the corresponding sensor electrode is configured to detect the nitrogen.

16. The sensing system of claim 1, the ammonia sensing element further comprising an ion-conducting substrate, wherein the first and second electrode assemblies are disposed on the ion-conducting substrate.

17. The sensing system of claim 16, wherein the first and second electrode assemblies are disposed on opposite surfaces of the ion-conducting substrate.

18. The sensing system of claim 1, the ammonia sensing element further comprising:
a non-ion-conducting substrate, wherein the first and second electrode assemblies are disposed on the non-ion-conducting substrate; and
an ion-conducting material disposed within at least one of the first and second electrode assemblies, the ion-conducting material disposed between a catalyst and a corresponding sensor electrode of the electrode assembly.

19. A sensing apparatus to measure ammonia in a gas mixture, the sensing apparatus comprising a sensing element, the sensing element comprising:
a substrate;
a first electrode assembly comprising a first sensor electrode coupled to the substrate, the first electrode assembly to react to the ammonia in the gas mixture;
a second electrode assembly comprising a second sensor electrode coupled to the substrate, the second electrode assembly to react to the ammonia in the gas mixture, wherein the first and second sensor electrodes comprise substantially similar materials and substantially similar microstructures; and
electrical leads coupled to the first and second electrode assemblies, the electrical leads to transmit a differential electrical signal from the first and second electrode assemblies in response to the ammonia detected by the first and second electrode assemblies.

20. The sensing apparatus of claim 19, further comprising first and second heaters disposed relative to the first and second sensor electrodes, the first heater to heat the first sensor electrode to a first operating temperature, and the second heater to heat the second sensor electrode to a second operating temperature different from the first operating temperature.

21. The sensing apparatus of claim 19, wherein the first sensor electrode comprises at least one physical dimension that is different from a corresponding physical dimension of the second sensor electrode, wherein the physical dimensions of the first and second sensor electrodes comprise different areas or different thicknesses.

22. The sensing apparatus of claim 19, wherein at least one sensor electrode of the first and second sensor electrodes comprises a noble metal.

23. The sensing apparatus of claim 19, wherein at least one sensor electrode of the first and second sensor electrodes comprises a metal oxide.

24. The sensing apparatus of claim 19, wherein the substrate comprises an ion-conducting substrate.

25. The sensing apparatus of claim 24, wherein the ion-conducting substrate comprises an oxygen ion-conducting substrate.

26. The sensing apparatus of claim 19, wherein the substrate comprises a non-ion-conducting substrate.

27. The sensing apparatus of claim 26, wherein at least one of the first and second electrode assemblies further comprises an ion-conducting material disposed relative to the corresponding sensor electrode.

28. The sensing apparatus of claim 19, wherein the first and second electrode assemblies are disposed on opposite surfaces of the substrate.

29. The sensing apparatus of claim 19, further comprising a sulfur absorption material disposed relative to the substrate, the sulfur absorption material to absorb sulfur from the gas mixture.

30. The sensing apparatus of claim 19, further comprising an oxygen sensor to detect oxygen in the gas mixture.

31. The sensing apparatus of claim 30, further comprising:
an oxygen sensor to detect oxygen in the gas mixture and to produce an oxygen electrical signal; and
an electronic control module coupled to the oxygen sensor and the first and second electrode assemblies to compute an ammonia measurement based on the differential electrical signal and the oxygen electrical signal.

32. The sensing apparatus of claim 19, further comprising a NOₓ sensor to detect NOₓ in the gas mixture.

33. The sensing apparatus of claim 32, further comprising:
an NOₓ sensor to detect oxygen in the gas mixture and to produce an NOₓ electrical signal; and
an electronic control module coupled to the NOₓ sensor and the first and second electrode assemblies to compute an ammonia measurement based on the differential electrical signal and the NOₓ electrical signal.

34. The sensing apparatus of claim 19, further comprising an electronic control module coupled to the sensing element, the electronic control module to convert the differential electrical signal to an ammonia measurement.

35. The sensing apparatus of claim 34, further comprising a heater controller coupled to the sensing element, the heater controller to control a heater within the sensing element to heat at least one of the first and second electrode assemblies to an operating temperature.

36. The sensing apparatus of claim 35, further comprising a temperature sensor coupled to the processor, the temperature sensor to provide a temperature feedback signal for at least one of the first and second electrode assemblies.

37. The sensing apparatus of claim 34, wherein the electronic control module comprises:
an electronic memory device to store a lookup table of a plurality of ammonia measurement values indexed by a corresponding plurality of differential electrical signal values; and
a processor coupled to the electronic memory device, the processor to reference the lookup table in the electronic memory device to determine the ammonia measurement.

38. The sensing apparatus of claim 34, the electronic control module comprising an electronic memory device to store machine readable instructions that, when executed by a processor, cause the electronic control module to compute the ammonia measurement based on a value of the differential electrical signal.

39. The sensing apparatus of claim 19, the electronic control module comprising:
an electronic memory device to store a set of theoretical or empirical equations; and
a processor coupled to the electronic memory device, the processor to reference the set of theoretical or empirical equations to determine the ammonia measurement.

40. The sensing system of claim 19, further comprising a bias voltage or a bias current applied between at least two of the electrodes to reduce gas cross-sensitivities.

41. A sensing apparatus to measure ammonia in a gas mixture, the sensing apparatus comprising a sensing element, the sensing element comprising:
a substrate;
a first electrode assembly comprising a first sensor electrode coupled to the substrate, the first electrode assembly to react to the ammonia in the gas mixture;
a second electrode assembly comprising a second sensor electrode coupled to the substrate, the second electrode assembly to react to the ammonia in the gas mixture, wherein the first and second sensor electrodes comprise substantially similar materials and dissimilar microstructures; and
electrical leads coupled to the first and second electrode assemblies, the electrical leads to transmit a differential electrical signal from the first and second electrode assemblies in response to the ammonia detected by the first and second electrode assemblies.

42. The sensing apparatus of claim 41, wherein the substantially similar materials of the first and second sensor electrodes comprise different porosities according to a nature of the porosities, a quantity of the porosities, or both the nature and the quantity of the porosities.

43. The sensing apparatus of claim 41, wherein the difference in porosity of the substantially similar materials results from different temperatures of sintering the first and second sensor electrodes.

44. The sensing apparatus of claim 41, wherein at least one sensor electrode of the first and second sensor electrodes comprises a noble metal.

45. The sensing apparatus of claim 41, wherein at least one sensor electrode of the first and second sensor electrodes comprises a metal oxide.

46. The sensing apparatus of claim 41, wherein the substrate comprises an ion-conducting substrate.

47. The sensing apparatus of claim 46, wherein the ion-conducting substrate comprises an oxygen ion-conducting substrate.

48. The sensing apparatus of claim 41, wherein the substrate comprises a non-ion-conducting substrate.

49. The sensing apparatus of claim 48, wherein at least one of the first and second electrode assemblies further comprises an ion-conducting material disposed relative to the corresponding sensor electrode.

50. The sensing apparatus of claim 41, wherein the first and second electrode assemblies are disposed on opposite surfaces of the substrate.

51. The sensing apparatus of claim 41, further comprising a sulfur absorption material disposed relative to the substrate, the sulfur absorption material to absorb sulfur from the gas mixture.

52. The sensing apparatus of claim 41, further comprising an oxygen sensor to detect oxygen in the gas mixture.

53. The sensing apparatus of claim 52, further comprising:
an oxygen sensor to detect oxygen in the gas mixture and to produce an oxygen electrical signal; and
an electronic control module coupled to the oxygen sensor and the first and second electrode assemblies to compute an ammonia measurement based on the differential electrical signal and the oxygen electrical signal.

54. The sensing apparatus of claim 41, further comprising a NOₓ sensor to detect NOₓ in the gas mixture.

55. The sensing apparatus of claim 54, further comprising:
an NOₓ sensor to detect oxygen in the gas mixture and to produce an NOₓ electrical signal; and
an electronic control module coupled to the NOₓ sensor and the first and second electrode assemblies to compute an ammonia measurement based on the differential electrical signal and the NOₓ electrical signal.

56. The sensing apparatus of claim 41, further comprising an electronic control module coupled to the sensing element, the electronic control module to convert the differential electrical signal to an ammonia measurement.

57. The sensing apparatus of claim 56, further comprising a heater controller coupled to the sensing element, the heater controller to control a heater within the sensing element to heat at least one of the first and second electrode assemblies to an operating temperature.

58. The sensing apparatus of claim 57, further comprising a temperature sensor coupled to the processor, the temperature sensor to provide a temperature feedback signal for at least one of the first and second electrode assemblies.

59. The sensing apparatus of claim 56, wherein the electronic control module comprises:
an electronic memory device to store a lookup table of a plurality of ammonia measurement values indexed by a corresponding plurality of differential electrical signal values; and
a processor coupled to the electronic memory device, the processor to reference the lookup table in the electronic memory device to determine the ammonia measurement.

60. The sensing apparatus of claim 56, further comprising an electronic memory device to store machine readable instructions that, when executed by a processor, cause the electronic control module to compute the ammonia measurement based on a value of the differential electrical signal.

61. The sensing system of claim 41, the electronic control module comprising:
an electronic memory device to store a set of theoretical or empirical equations; and
a processor coupled to the electronic memory device, the processor to reference the set of theoretical or empirical equations to determine the ammonia measurement.

62. The sensing system of claim 41, further comprising a bias voltage or a bias current applied between at least two of the electrodes to reduce gas cross-sensitivities.

63. A sensing apparatus to measure ammonia in a gas mixture, the sensing apparatus comprising a sensing element, the sensing element comprising:
a substrate;
a first electrode assembly comprising a first sensor electrode coupled to the substrate, the first electrode assembly to react to the ammonia in the gas mixture;
a second electrode assembly comprising a second sensor electrode coupled to the substrate, the second electrode assembly to react to the ammonia in the gas mixture, wherein the first and second sensor electrodes comprise dissimilar materials; and
electrical leads coupled to the first and second electrode assemblies, the electrical leads to transmit a differential electrical signal from the first and second electrode assemblies in response to the ammonia detected by the first and second electrode assemblies.

64. The sensing apparatus of claim 63, wherein at least one sensor electrode of the first and second sensor electrodes comprises a noble metal.

65. The sensing apparatus of claim 63, wherein at least one sensor electrode of the first and second sensor electrodes comprises a metal oxide.

66. The sensing apparatus of claim 63, wherein the substrate comprises an ion-conducting substrate.

67. The sensing apparatus of claim 66, wherein the ion-conducting substrate comprises an oxygen ion-conducting substrate.

68. The sensing apparatus of claim 63, wherein the substrate comprises a non-ion-conducting substrate.

69. The sensing apparatus of claim 68, wherein at least one of the first and second electrode assemblies further comprises an ion-conducting material disposed relative to the corresponding sensor electrode.

70. The sensing apparatus of claim 63, wherein the first and second electrode assemblies are disposed on opposite surfaces of the substrate.

71. The sensing apparatus of claim 63, further comprising a sulfur absorption material disposed relative to the substrate, the sulfur absorption material to absorb sulfur from the gas mixture.

72. The sensing apparatus of claim 63, further comprising an oxygen sensor to detect oxygen in the gas mixture.

73. The sensing apparatus of claim 72, further comprising:
an oxygen sensor to detect oxygen in the gas mixture and to produce an oxygen electrical signal; and
an electronic control module coupled to the oxygen sensor and the first and second electrode assemblies to compute an ammonia measurement based on the differential electrical signal and the oxygen electrical signal.

74. The sensing apparatus of claim 63, further comprising a NOₓ sensor to detect NOₓ in the gas mixture.

75. The sensing apparatus of claim 74, further comprising:
an NOₓ sensor to detect oxygen in the gas mixture and to produce an NOₓ electrical signal; and
an electronic control module coupled to the NOₓ sensor and the first and second electrode assemblies to compute an ammonia measurement based on the differential electrical signal and the NOₓ electrical signal.

76. The sensing apparatus of claim 63, further comprising an electronic control module coupled to the sensing element, the electronic control module to convert the differential electrical signal to an ammonia measurement.

77. The sensing apparatus of claim 76, further comprising a heater controller coupled to the sensing element, the heater controller to control a heater within the sensing element to heat at least one of the first and second electrode assemblies to an operating temperature.

78. The sensing apparatus of claim 77, further comprising a temperature sensor coupled to the processor, the temperature sensor to provide a temperature feedback signal for at least one of the first and second electrode assemblies.

79. The sensing apparatus of claim 73, wherein the electronic control module comprises:
an electronic memory device to store a lookup table of a plurality of ammonia measurement values indexed by a corresponding plurality of differential electrical signal values; and
a processor coupled to the electronic memory device, the processor to reference the lookup table in the electronic memory device to determine the ammonia measurement.

80. The sensing apparatus of claim 73, wherein the electronic control module comprises an electronic memory device to store machine readable instructions that, when executed by a processor, cause the electronic control module to compute the ammonia measurement based on a value of the differential electrical signal.

81. The sensing apparatus of claim 73, the electronic control module comprising:
an electronic memory device to store a set of theoretical or empirical equations; and
a processor coupled to the electronic memory device, the processor to reference the set of theoretical or empirical equations to determine the ammonia measurement.

82. The sensing apparatus of claim 63, further comprising a bias voltage or a bias current applied between at least two of the electrodes to reduce gas cross-sensitivities.

83. A sensing apparatus to measure ammonia in a gas mixture, the sensing apparatus comprising a sensing element, the sensing element comprising:
a substrate;
a first electrode assembly comprising a first sensor electrode coupled to the substrate, the first electrode assembly to react to the ammonia in the gas mixture;
a second electrode assembly comprising a second sensor electrode coupled to the substrate, the second electrode assembly to react to the ammonia in the gas mixture, wherein at least one electrode assembly of the first and second electrode assemblies comprises a catalyst disposed relative to the corresponding sensor electrode, the catalyst comprising a catalytically active material to selectively oxidize at least some of the ammonia to nitrogen, nitride, or nitric oxide, wherein the corresponding sensor electrode is configured to detect the nitrogen, nitride, or nitric oxide; and
electrical leads coupled to the first and second electrode assemblies, the electrical leads to transmit a differential electrical signal from the first and second electrode assemblies in response to the ammonia detected by the first and second electrode assemblies.

84. The sensing apparatus of claim 83, wherein the electrode assembly comprising the catalyst further comprises a second catalyst disposed relative to the first catalyst, the second catalyst comprising another catalytically active material.

85. The sensing apparatus of claim 83, wherein at least one sensor electrode of the first and second sensor electrodes comprises a noble metal.

86. The sensing apparatus of claim 83, wherein at least one sensor electrode of the first and second sensor electrodes comprises a metal oxide.

87. The sensing apparatus of claim 83, wherein the substrate comprises an ion-conducting substrate.

88. The sensing apparatus of claim 86, wherein the ion-conducting substrate comprises an oxygen ion-conducting substrate.

89. The sensing apparatus of claim 83, wherein the substrate comprises a non-ion-conducting substrate.

90. The sensing apparatus of claim 83, wherein at least one of the first and second electrode assemblies further comprises an ion-conducting material disposed relative to the corresponding sensor electrode.

91. The sensing apparatus of claim 83, wherein the first and second electrode assemblies are disposed on opposite surfaces of the substrate.

92. The sensing apparatus of claim 83, further comprising a sulfur absorption material disposed relative to the substrate, the sulfur absorption material to absorb sulfur from the gas mixture.

93. The sensing apparatus of claim 83, further comprising an oxygen sensor to detect oxygen in the gas mixture.

94. The sensing apparatus of claim 93, further comprising:
an oxygen sensor to detect oxygen in the gas mixture and to produce an oxygen electrical signal; and
an electronic control module coupled to the oxygen sensor and the first and second electrode assemblies to compute an ammonia measurement based on the differential electrical signal and the oxygen electrical signal.

95. The sensing apparatus of claim 83, further comprising a NOₓ sensor to detect NOₓ in the gas mixture.

96. The sensing apparatus of claim 95, further comprising:
an NOₓ sensor to detect oxygen in the gas mixture and to produce an NOₓ electrical signal; and
an electronic control module coupled to the NOₓ sensor and the first and second electrode assemblies to compute an ammonia measurement based on the differential electrical signal and the NOₓ electrical signal.

97. The sensing apparatus of claim 83, further comprising an electronic control module coupled to the sensing element, the electronic control module to convert the differential electrical signal to an ammonia measurement.

98. The sensing apparatus of claim 97, further comprising a heater controller coupled to the sensing element, the heater controller to control a heater within the sensing element to heat at least one of the first and second electrode assemblies to an operating temperature.

99. The sensing apparatus of claim 98, further comprising a temperature sensor coupled to the processor, the temperature sensor to provide a temperature feedback signal for at least one of the first and second electrode assemblies.

100. The sensing apparatus of claim 97, wherein the electronic control module comprises:
an electronic memory device to store a lookup table of a plurality of ammonia measurement values indexed by a corresponding plurality of differential electrical signal values; and
a processor coupled to the electronic memory device, the processor to reference the lookup table in the electronic memory device to determine the ammonia measurement.

101. The sensing apparatus of claim 97, wherein the electronic control module comprises an electronic memory device to store machine readable instructions that, when executed by a processor, cause the electronic control module to compute the ammonia measurement based on a value of the differential electrical signal.

102. The sensing system of claim 97, the electronic control module comprising:
an electronic memory device to store a set of theoretical or empirical equations; and
a processor coupled to the electronic memory device, the processor to reference the set of theoretical or empirical equations to determine the ammonia measurement.

103. The sensing system of claim 83, further comprising a bias voltage or a bias current applied between at least two of the electrodes to reduce gas cross-sensitivities.

104. A sensing apparatus to measure ammonia in a gas mixture, the sensing apparatus comprising:
an ion-conducting substrate, wherein the ion-conducting substrate comprises yttria stabilized zirconia;
a first sensor electrode disposed on a surface of the substrate, the first sensor electrode to react to the ammonia in the gas mixture, wherein the first sensor electrode comprises platinum;
a second sensor electrode disposed on the surface of the substrate, the second sensor electrode to react to the ammonia in the gas mixture, wherein the second sensor electrode comprises tungsten oxide;
wherein the first and second sensor electrodes are configured to generate a differential electrical signal in response to the detected ammonia;
a heater indirectly coupled to the first and second sensor electrodes, the heater to heat the first and second sensor electrodes to an operating temperature;
a thermocouple material coupled between the heater and the sensor electrodes, the thermocouple material to transfer heat from the heater to the first and second sensor electrodes; and
a housing for the ion-conducting substrate and the first and second sensor electrodes, the housing comprising an aperture to allow a volume of the gas mixture to flow in proximity to the first and second sensor electrodes.

105. A sensing apparatus to measure ammonia in a gas mixture, the sensing apparatus comprising:
a substrate;
a first sensor electrode disposed on a surface of the substrate, the first sensor electrode to react to the ammonia in the gas mixture, wherein the first sensor electrode comprises platinum;
a second sensor electrode disposed on the surface of the substrate, wherein the second sensor electrode comprises platinum; and
a catalyst disposed on the second sensor electrode, the catalyst comprising a catalytically active material to selectively oxidize at least some of the ammonia to a nitrogen component, wherein the catalytically active material comprises ruthenium oxide, wherein the second sensor electrode is configured to detect the nitrogen component, wherein the first and second sensor electrodes are configured to generate a differential electrical signal in response to the detected ammonia and the detected nitrogen component.

106. The sensing apparatus of claim 105, wherein the first and second sensing electrodes are disposed on the same side of the substrate.

107. The sensing apparatus of claim 105, wherein the first and second sensing electrodes are disposed on opposite sides of the substrate.

108. A sensing apparatus to measure ammonia in a gas mixture, the sensing apparatus comprising:
means for generating a differential electrical signal in response to a first reaction involving the ammonia in the gas mixture and a second reaction involving the ammonia in the gas mixture, wherein the second reaction is dissimilar from the first reaction; and
means for determining an amount of ammonia in the gas mixture based on the differential electrical signal.

109. The sensing apparatus of claim 108, further comprising:
means for converting at least some of the ammonia in the gas mixture to a nitrogen component; and
means for detecting the nitrogen component.

110. The sensing apparatus of claim 108, further comprising means for controlling an amount of the ammonia in the gas mixture.
